(19) United States
(12) Patent Application Publication
(10) Pub. No.: US 2026/0180269 A1
(43) Pub. Date: Jun. 25, 2026

(54) ELECTRICAL CONNECTOR

(71) Applicant: J.S.T. Mfg. Co., Ltd., Tokyo (JP)

(72) Inventor: Masaki TSUJIMOTO, Yokohama-shi (JP)

(73) Assignee: J.S.T. Mfg. Co., Ltd., Tokyo (JP)

(21) Appl. No.: 19/401,871

(22) Filed: Nov. 26, 2025

(30) Foreign Application Priority Data
Dec. 20, 2024 (JP) 2024-225788

(51) Int. Cl. H01R 24/64; H01R 12/72

(52) U.S. Cl. CPC H01R 24/64; H01R 12/722

(57) ABSTRACT

This electrical connector includes a contact and a housing to which a plug connector is mated. The contact has a body portion held by a bottom wall portion of the housing, and a plug connection portion that bends at an acute angle from the body portion and extends in a cantilevered manner in an opening of the housing and that is for connection to the plug contact. The plug connection portion has a plate spring portion that extends from the body portion, an inclined portion that extends in an inclined manner from the plate spring portion so as to protrude away from the body portion relative to the plate spring portion, and a contact portion that is provided on the inclined portion and is for coming into contact with and being connected to the plug contact.

### CROSS-REFERENCE TO RELATED APPLICATION

This application claims priority to Japanese Patent Application No. 2024-225788. The entire disclosure of Japanese Patent Application No. 2024-225788 is hereby incorporated herein by reference.

### BACKGROUND OF THE INVENTION

### 1. Field of the Invention

The present invention relates to a receptacle-type electrical connector that is disposed on a substrate and to which a plug connector having plug contacts is mated and connected.

### 2. Description of Related Art

Conventionally, there are known receptacle-type electrical connectors that are disposed on a substrate and to which a plug connector having plug contacts is mated and connected, and such receptacle-type electrical connectors are used as LAN connectors, for example. The plug connector that is connected to such an electrical connector includes a plurality of plug contacts that are plate-shaped, for example, and electrode separation walls are provided between the plug contacts to insulate the plug contacts from each other. The electrical connector to which the plug connector is connected includes a housing provided with an opening into which the plug connector is fitted, and a plurality of contacts that are held in the housing and come into contact with and are connected to the plug contacts. Each of the contacts is provided with a body portion held in the housing, and a plug connection portion that extends from the body portion held in the housing into the opening of the housing and comes into contact with a corresponding plug contact. A known example of such an electrical connector is disclosed in Patent Document 1, for example.

Patent Document 1 discloses a receptacle 100A as an electrical connector that is disposed on a substrate and to which a plug 80, which is a plug connector having plug contacts, is mated and connected. The plug 80 (plug connector) to be connected to the receptacle 100A, includes a plurality of electrical contacts 19 (plug contacts), and electrode separation walls are provided between the plug contacts to insulate the plug contacts from each other. The receptacle 100A to which the plug connector is connected includes an insulating housing 10 provided with an opening 40 into which the plug connector is fitted, and a plurality of contacts 20 that are held in the insulating housing 10 and come into contact with and are connected to the plug contacts. Each of the contacts 20 is provided with a body portion held in the insulating housing 10, and a contact spring 24 (plug connection portion) that bends from the body portion held in the insulating housing 10 and extends in a cantilevered manner in an oblique direction inside the opening 40 of the insulating housing 10, and comes into contact with a corresponding plug contact. When the plug connector is mated and connected to the receptacle 100A, the tip-side portions of the plug contacts inserted into the opening 40 of the insulating housing 10 come into contact with the contact springs 24. The contact springs 24 (plug connection portions) elastically deform and flex upon coming into contact with the tip-side portions of the plug contacts, and are electrically connected to the plug contacts.

### PRIOR ART DOCUMENTS

### Patent Document

Patent Document 1: JP 2000-268921A

### SUMMARY OF THE INVENTION

In the receptacle 100A of Patent Document 1, the contacts 20 held in the insulating housing 10 are provided with the contact springs 24 (plug connection portions) that come into contact with and are connected to the plug contacts. The contact springs 24 are configured to bend from the body portions of the contacts 20 held in the insulating housing 10 and extend in a cantilevered manner in an oblique direction inside the opening 40 of the insulating housing 10, and come into contact with the tip-side portions of the plug contacts. With this configuration, when the plug connector is mated to the insulating housing 10, large regions of the contact springs 24 (plug connection portions) are located next to the electrode separation walls of the plug connector. Therefore, if the plug connector becomes displaced so as to twist relative to the insulating housing 10, large regions of the contact springs 24 of the contacts 20 interfere with the electrode separation walls of the plug connector, and the contact springs 24 (plug connection portions) are overall pushed down toward the body portions of the contacts 20. As a result, if the plug connector becomes displaced so as to twist relative to the insulating housing 10, the contact springs 24 (plug connection portions) of the contacts 20 and the plug contacts momentarily separate from each other such that the contact between them is momentarily lost, and thus the electrical connection between the contacts 20 and the plug contacts is momentarily lost.

In view of the above, an object of the present invention is to provide a receptacle-type electrical connector that is disposed on a substrate and to which a plug connector having plug contacts is mated and connected, and that can suppress the case where the electrical connection between the contacts and the plug contacts is momentarily lost even if the plug connector becomes displaced so as to twist relative to the housing.

(1) An electrical connector according to an aspect of the present invention for solving the above-described problem is a receptacle-type electrical connector to be disposed on a substrate and to which a plug connector having a plug contact is to be mated and connected. The electrical connector according to this aspect of the present invention includes: a contact having one end side configured to be connected to the substrate and electrically connected to the substrate, and another end side configured to come into contact with the plug contact and be electrically connected to the plug contact; and a housing configured to hold the contact, and to which the plug connector is mateable, wherein the housing has: an opening into which the plug connector is fitted; and a bottom wall portion configured to hold the contact, the contact has: a body portion extending in a straight line and configured to be held by the bottom wall portion of the housing; a substrate connection portion extending from one end side of the body portion and configured to be connected to the substrate; and a plug connection portion bending at an acute angle relative to the body portion from another end side of the body portion and extending in a cantilevered manner inside the opening of the housing, and configured to, upon coming into contact with the plug contact, elastically deform and flex and be connected to the plug contact, and the plug connection portion has: a plate spring portion bending from the body portion and then extending in a straight line; an inclined portion extending in an inclined manner from the plate spring portion so as to protrude away from the body portion relative to the plate spring portion; and a contact portion provided on the inclined portion and configured to come into contact with the plug contact and be electrically connected to the plug contact.

According to this configuration, the contact is provided with the plug connection portion that bends from the body portion, which is held by the bottom wall portion of the housing, at an acute angle relative to the body portion, and extends inside the opening of the housing. The plug connection portion is provided with the plate spring portion that bends from the body portion and then extends in a straight line, the inclined portion that extends in an inclined manner from the plate spring portion so as to protrude away from the body portion relative to the plate spring portion, and the contact portion that is provided on the inclined portion and comes into contact with and is connected to the plug contact. In this way, in the plug connection portion of the contact, the inclined portion provided with the contact portion is provided so as to protrude from the plate spring portion, and therefore when the plug connector is mated and connected to the housing, almost no portion of the plate spring portion is located next to the electrode separation walls of the plug connector, and only the inclined portion is located at such a position. Therefore, even if the plug connector becomes displaced so as to twist relative to the housing, the portion of the contact that interferes with the electrode separation walls of the plug connector is substantially only the inclined portion, and the plug connection portion is prevented from overall being pushed down toward the bottom wall portion of the housing. Accordingly, even if the plug connector becomes displaced so as to twist relative to the housing, it is possible to suppress the case where the plug connection portion of the contact momentarily separates from the plug contact and the contact therebetween is momentarily lost, and it is possible to suppress the case where the electrical connection between the contact and the plug contact is momentarily lost.

Therefore, according to the above configuration, in the receptacle-type electrical connector that is disposed on the substrate and to which the plug connector having the plug contact is to be mated and connected, even if the plug connector becomes displaced so as to twist relative to the housing, it is possible to suppress the case where the electrical connection between the contact and the plug contact is momentarily lost.

(2) An aspect is possible in which the plate spring portion bends from the body portion and then extends so as to form a predetermined first angle with the body portion, and the inclined portion extends in an inclined manner from the plate spring portion so as to form a predetermined second angle with the body portion, the second angle being larger than the first angle.

According to this configuration, the angle of the inclined portion of the plug connection portion relative to the body portion is set larger than the angle of the plate spring portion of the plug connection portion relative to the body portion, and therefore the plug connection portion can be easily formed with a structure in which, when the plug connector is mated to the housing, almost no portion of the plate spring portion is located next to the electrode separation wall of the plug connector, and the inclined portion is located at such a position.

(3) An aspect is possible in which the plug contact is provided with a bottom face portion configured to face the bottom wall portion of the housing when the plug connector is mated to the housing, and the contact portion is provided as a highest portion of the inclined portion that extends in an inclined manner from the plate spring portion so as to protrude away from the body portion relative to the plate spring portion, and the contact portion is connected to the plug contact by coming into contact with the bottom face portion.

According to this configuration, the contact portion of the plug connection portion is connected to the plug contact by coming into contact with the bottom face portion of the plug contact, and therefore even if the plug connector becomes displaced so as to twist relative to the housing, the contact portion is likely to follow movement of the plug contact, and the contact portion is even less likely to separate from the plug contact. This further suppresses the case where the electrical connection between the contact and the plug contact is momentarily lost.

(4) An aspect is possible in which the inclined portion bends so as to be inclined relative to the plate spring portion.

With this configuration, with a simple structure in which the inclined portion is formed to be bent relative to the plate spring portion, it is possible to construct the contact with a structure in which, even if the plug connector becomes displaced so as to twist relative to the housing, the portion of the contact that interferes with the electrode separation wall of the plug connector is substantially only the inclined portion, and the plug connection portion can be prevented from overall being pushed down toward the bottom wall portion of the housing.

Note that the above and other objects, features, and advantages of the present invention will become apparent from the following description taken in conjunction with the accompanying drawings.

### BRIEF DESCRIPTION OF THE DRAWINGS

FIGS. 1A and 1B are perspective views of an electrical connector according to an embodiment of the present invention.

FIG. 2 is a perspective cross-sectional view of the electrical connector connected to a substrate, together with a plug connector to be connected to the electrical connector.

FIG. 3 is an exploded perspective view of the electrical connector.

FIG. 4 is a perspective cross-sectional view of the plug connector to be connected to the electrical connector.

FIG. 5A is a front view of the plug connector, and FIG. 5B is a bottom view of the plug connector.

FIG. 6 is a perspective cross-sectional view of the electrical connector.

FIG. 7A is a front view of the electrical connector, and FIG. 7B is a rear view of the electrical connector.

FIG. 8 is a cross-sectional view of the electrical connector.

FIGS. 9A and 9B show a contact of the electrical connector, with FIG. 9A being a perspective view and FIG. 9B being a side view.

FIG. 10 is a cross-sectional view of a state before the electrical connector and the plug connector are connected to each other.

FIG. 11 is a perspective cross-sectional view of a state in which the plug connector is being mated and connected to the electrical connector.

FIG. 12 is a cross-sectional view of a state in which the plug connector is being mated and connected to the electrical connector.

FIG. 13 is a perspective cross-sectional view of a state in which the plug connector has been mated and connected to the electrical connector.

FIG. 14 is a cross-sectional view of a state in which the plug connector has been mated and connected to the electrical connector.

FIG. 15 is a cross-sectional view of a state in which the plug connector has been mated and connected to the electrical connector.

FIG. 16 is a perspective cross-sectional view of an electrical connector according to a variation.

FIG. 17 is a cross-sectional view of the electrical connector according to the variation.

FIGS. 18A and 18B show a contact of the electrical connector according to the variation, with FIG. 18A being a perspective view and FIG. 18B being a side view.

FIG. 19 is a perspective cross-sectional view of a state in which a plug connector has been mated and connected to the electrical connector according to the variation.

FIG. 20 is a cross-sectional view of a state in which the plug connector has been mated and connected to the electrical connector according to the variation.

### DETAILED DESCRIPTION OF THE INVENTION

Hereinafter, embodiments of the present invention will be described with reference to the drawings. The present invention is broadly applicable to a receptacle-type electrical connector that is disposed on a substrate and to which a plug connector having plug contacts is mated and connected.

### Schematic Configuration of Electrical Connector and Plug Connector

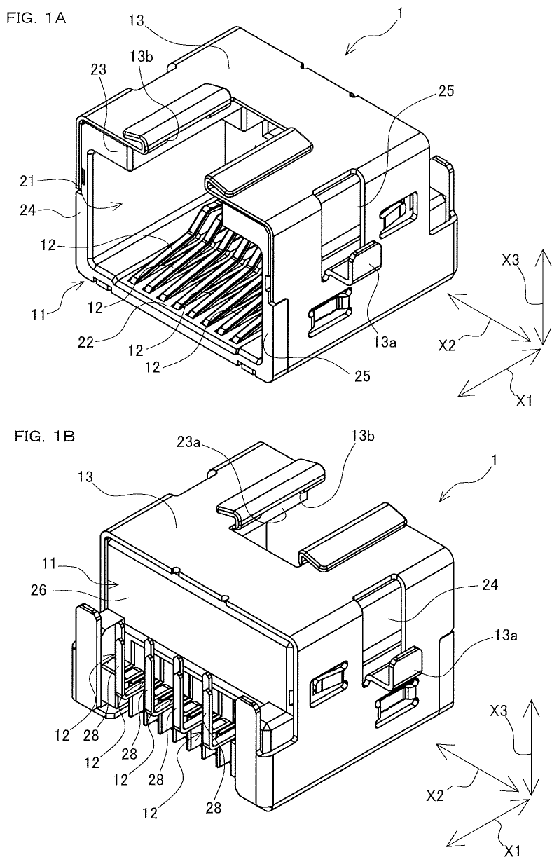

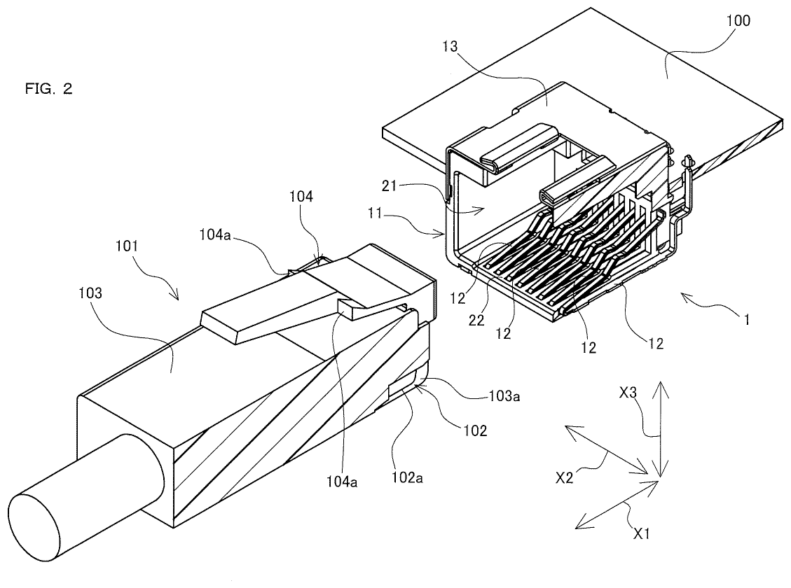

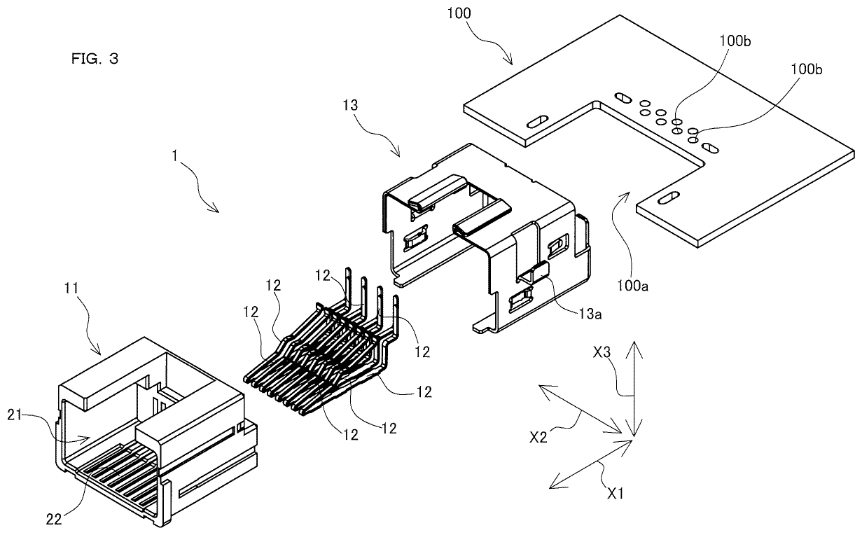

FIGS. 1A and 1B are perspective views of an electrical connector 1 according to an embodiment of the present invention. FIG. 2 is a perspective cross-sectional view of the electrical connector 1 connected to a substrate 100, and shows a plug connector 101 that is to be connected to the electrical connector 1. FIG. 3 is an exploded perspective view of the electrical connector 1. Note that in FIGS. 2 and 3, the electrical connector 1 is shown together with the substrate 100 to which the electrical connector 1 is connected. Also, FIGS. 2 and 3 show a state in which a portion of the substrate 100 has been cut away.

As shown in FIGS. 1A to 3, the electrical connector 1 is configured as a receptacle-type electrical connector that is disposed on the substrate 100 and to which the plug connector 101 having plug contacts 102 is mated and connected. The electrical connector 1 is disposed on the substrate 100 and is electrically connected to the substrate 100. A recession portion 100a cut out in a concave shape is provided in an edge portion of the substrate 100 on which the electrical connector 1 is disposed. The electrical connector 1 is disposed on the substrate 100 in a state of being fitted into the recession portion 100a of the substrate 100. The electrical connector 1 is disposed on the substrate 100 and electrically connected thereto, and then the plug connector 101 is mated and connected to the electrical connector 1 in that state.

The electrical connector 1 includes a housing 11, a plurality of contacts 12 held in the housing 11, and a shield member 13 mounted to the outer side of the housing 11, and is configured as an electrical connector to which the plug connector 101 is mated and connected.

The housing 11 is formed using an insulating resin material and has a basic outer shape of a substantially rectangular parallelepiped with a large opening in one end portion. The housing 11 holds a plurality of contacts 12 and is shaped as a case into which the plug connector 101 is fitted. The housing 11 has an opening 21 into which the plug connector 101 is fitted, and a bottom wall portion 22 that holds the contacts 12. The contacts 12 are held by the bottom wall portion 22 of the housing 11 and are arranged in a state of being exposed inside the opening 21 of the housing 11.

Each of the contacts 12 is formed using an electrically conductive metal material. The contacts 12 are each formed by bending a long, thin, and straight plate-shaped metal member. The contacts 12 are held in the housing 11 by being partially press-fitted into the bottom wall portion 22 of the housing 11. Also, each of the contacts 12 is configured such that one end side is connected to the substrate 100 and electrically connected to the substrate 100, and the other end side comes into contact with a corresponding plug contact 102 of the plug connector 101 and is electrically connected to the plug contact 102.

The shield member 13 is formed using a conductive metal material and is provided to shield the electrical connector 1 from electromagnetic noise. The shield member 13 is formed by stamping out and bending a metal plate, and is shaped so as to be mounted to the outer side of the housing 11. The shield member 13 is also provided with tabs 13a that are fitted into the substrate 100 when the electrical connector 1 is disposed on the substrate 100. The tabs 13a are fitted into holes provided in the substrate 100, and thereby the electrical connector 1 is disposed on and fixed to the substrate 100. The shield member 13 is also provided with an engaging portion 13b that engages with a lock arm 104 of the plug connector 101 when the plug connector 101 is mated and connected to the electrical connector 1. The engaging portion 13b is formed as a recessed cutout portion.

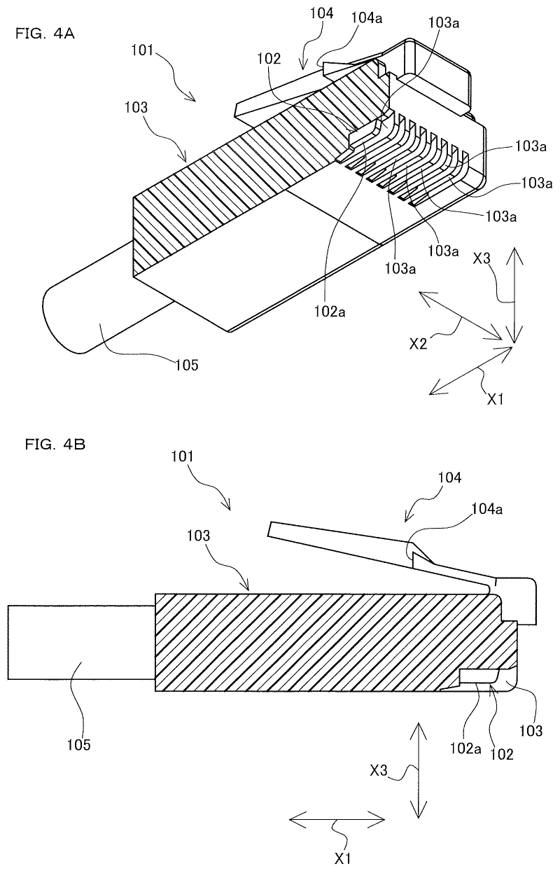

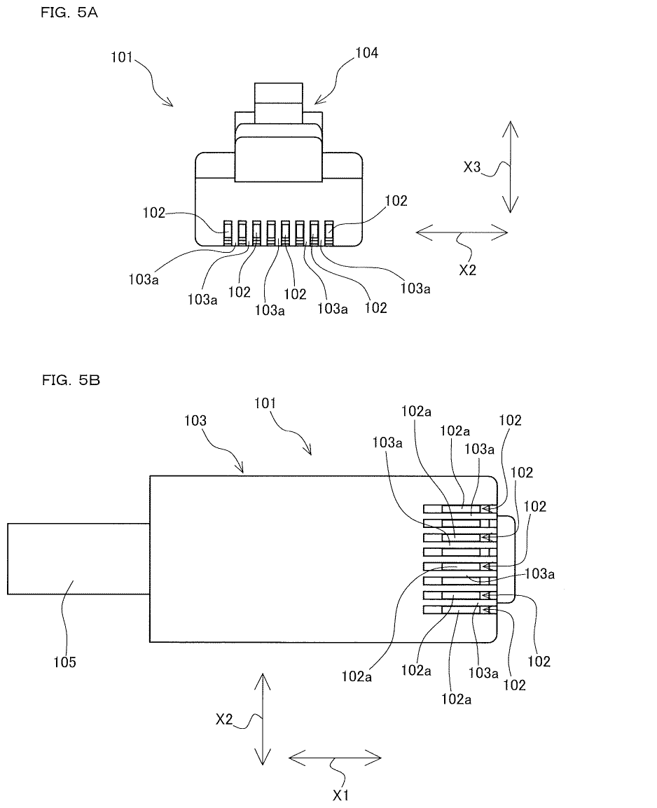

FIG. 4 is a perspective cross-sectional view of the plug connector 101 to be connected to the electrical connector 1. FIG. 5A is a front view of the plug connector 101, and FIG. 5B is a bottom view of the plug connector 101. As shown in FIGS. 2, 4, 5A, and 5B, the plug connector 101 that is mated and connected to the electrical connector 1 includes a plurality of plug contacts 102, a plug housing 103 that holds the plug contacts 102, and the lock arm 104 that is integrated with the plug housing 103.

Each of the plug contacts 102 is formed using a conductive metal material. Each of the plug contacts 102 is shaped as, for example, a plate having a long and thin substantially rectangular outer shape, and is held in the plug housing 103 by being inserted into a corresponding groove provided in the plug housing 103. When the plug connector 101 is mated and connected to the electrical connector 1, the plug contacts 102 respectively come into contact with and are electrically connected to the contacts 12 of the electrical connector 1. The plug contact 102 is provided with a bottom face portion 102a that faces the bottom wall portion 22 of the housing 11 when the plug connector 101 is mated to the housing 11 of the electrical connector 1. When the plug connector 101 is mated and connected to the electrical connector 1, at the bottom face portion 102a, the plug contacts 102 respectively come into contact with and are electrically connected to the contacts 12 held in the bottom wall portion 22 of the housing 11.

Furthermore, the plug contacts 102 are respectively electrically connected to the end portions of electrical wires (not shown) inside the plug housing 103. The electrical wires (not shown), which are respectively connected to the plug contacts 102 and extend from the plug housing 103 to the outside, are bundled together and housed in a tube 105, and extend from the plug housing 103 in that state.

The plug housing 103 is formed using an insulating resin material and has a basic outer shape of a substantially rectangular parallelepiped. The plug housing 103 holds the plug contacts 102, and is configured such that one end portion side extending in a substantially rectangular parallelepiped shape is fitted into the opening 21 of the housing 11 of the electrical connector 1.

The plug housing 103 is provided with a plurality of grooves into which the plug contacts 102 are respectively inserted. The plug contacts 102 are respectively inserted into the grooves in the plug housing 103, and are thereby held in the plug housing 103 in a state of being aligned parallel with each other. Furthermore, the plug contacts 102, which are respectively inserted into the grooves of the plug housing 103, are exposed to the outside through the grooves in the end portion of the plug housing 103 that is fitted into the opening 21 of the housing 11. When the plug connector 101 is mated and connected to the electrical connector 1, the exposed portions of the plug contacts 102 respectively come into contact with the contacts 12 of the electrical connector 1, and the plug contacts 102 are respectively electrically connected to the contacts 12.

Also, the plug housing 103 is provided with electrode separation walls 103a between adjacent plug contacts 102 that are held side by side in the plug housing 103, to provide insulation between the plug contacts 102. The electrode separation walls 103a are provided as wall portions that define the grooves into which the plug contacts 102 are inserted in the plug housing 103.

The lock arm 104 is provided as a lever-like member for engaging with the electrical connector 1 to lock the plug connector 101 to the electrical connector 1 when the plug connector 101 is mated and connected to the electrical connector 1. The lock arm 104 is provided so as to extend in a cantilevered manner from the plug housing 103 on the outside of the plug housing 103. The base portion of the lock arm 104 extending in a cantilevered manner from the plug housing 103 is integrated with the plug housing 103. The lock arm 104 extending in a cantilevered manner from the plug housing 103 is elastically deformable so as to be capable of flexing. When the plug connector 101 is connected to the electrical connector 1, the lock arm 104 is configured to temporarily elastically deform and flex upon coming into contact with the shield member 13 of the electrical connector 1, and then undergo elastic recovery and engage with the engaging portion 13b of the shield member 13. Note that the lock arm 104 is provided with step-like protruding engagement protrusion portions 104a on opposite sides in the width direction of the lock arm 104, at an intermediate portion of the portion extending in a cantilevered manner from the plug housing 103. The lock arm 104 is configured such that the engagement protrusion portions 104a engage with the engaging portion 13b of the shield member 13 of the electrical connector 1.

### Detailed Configuration of Electrical Connector

The configuration of the electrical connector 1 will be described in more detail below. In the following description, a mating direction X1, a width direction X2, and a height direction X3 of the electrical connector 1 are defined as shown by a double-headed arrow X1, a double-headed arrow X2, and a double-headed arrow X3, respectively, in FIGS. 1 to 5B and the drawings described later. The mating direction X1 is a direction parallel with the direction in which the plug connector 101 is mated to the electrical connector 1. The mating direction X1 of the electrical connector 1 is also the mating direction X1 of the plug connector 101. The mating direction X1 of the electrical connector 1 is also the mating direction X1 of the housing 11 and the mating direction X1 of the contacts 12. The width direction X2 is a direction perpendicular to the mating direction X1, and is an arrangement direction in which the contacts 12 held in the housing 11 are aligned in a row in the housing 11. The width direction X2 of the electrical connector 1 is also the width direction X2 of the plug connector 101. The width direction X2 of the electrical connector 1 is also the width direction X2 of the housing 11 and the width direction X2 of the contacts 12. The height direction X3 is a direction perpendicular to both the mating direction X1 and the width direction X2. The height direction X3 of the electrical connector 1 is also the height direction X3 of the plug connector 101. Moreover, the height direction X3 of the electrical connector 1 is also the height direction X3 of the housing 11 and the height direction X3 of the contacts 12.

### <Housing>

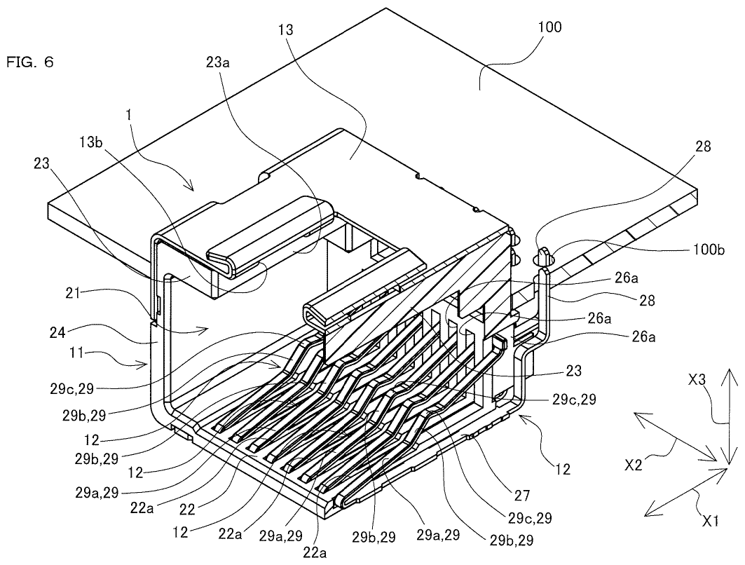

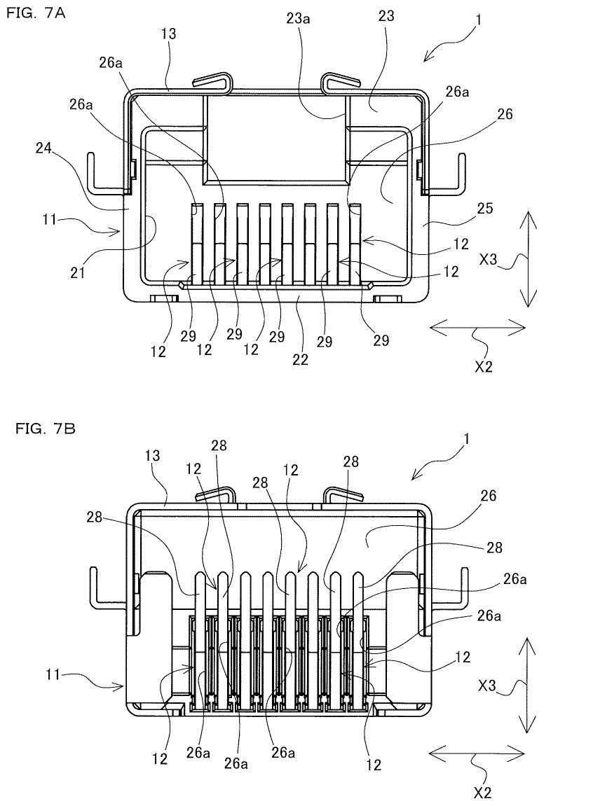

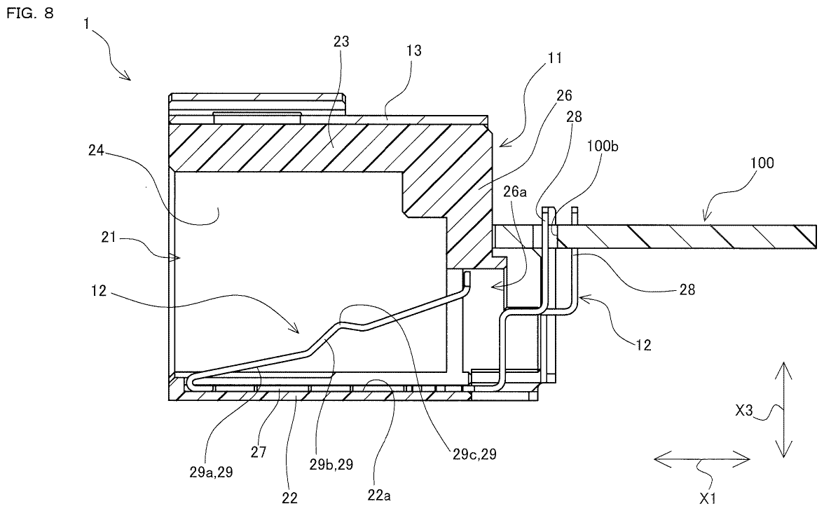

FIG. 6 is a perspective cross-sectional view of the electrical connector 1. FIG. 7A is a front view of the electrical connector 1, and FIG. 7B is a rear view of the electrical connector 1. FIG. 8 is a cross-sectional view of the electrical connector 1. Note that in FIGS. 6 and 8, the electrical connector 1 is shown together with the substrate 100 to which the electrical connector 1 is connected.

As shown in FIGS. 1A to 3 and 6 to 8, the housing 11 is formed of a resin material and has a substantially rectangular parallelepiped outer shape, and is provided with an opening 21, into which the plug connector 101 is fitted, on one end side in the mating direction X1. The region inside the opening 21 in the housing 11 forms an internal space in which the end portion of the plug connector 101 fitted into the opening 21 is accommodated. The housing 11 has a bottom wall portion 22 and a ceiling wall portion 23 that face each other in the height direction X3, a pair of side wall portions 24 and 25 that face each other in the width direction X2, and an end wall portion 26 provided on the side opposite to the opening 21 in the mating direction X1. The bottom wall portion 22, the ceiling wall portion 23, the pair of side wall portions 24 and 25, and the end wall portion 26 are integrated with each other such that the housing 11 has a basic outer shape of a substantially rectangular parallelepiped with one end side in the mating direction X1 open at the opening 21.

The housing 11 is configured to hold the contacts 12 in the bottom wall portion 22. The bottom wall portion 22 of the housing 11 is provided with a plurality of holding grooves 22a for respectively holding the contacts 12. The holding grooves 22a are provided as grooves that are open toward the inside of the housing 11 in the bottom wall portion 22 and extend along the mating direction X1. The contacts 12 are respectively press-fitted into the holding grooves 22a in the bottom wall portion 22 from the end wall portion 26 side along the mating direction X1. Note that as will be described later, the body portions 27 of the contacts 12 are the portions that are press-fitted into the holding grooves 22a. The contacts 12 are held in the bottom wall portion 22 by being press-fitted into the holding grooves 22a. Note that the end wall portion 26 is provided with a plurality of slit grooves 26a that are respectively in communication with the holding grooves 22a. The slit grooves 26a pass through the end wall portion 26 so as to be in communication with the holding grooves 22a. The contacts 12 are inserted into the housing 11 through the slit grooves 26a and press-fitted into the holding grooves 22a.

Also, the ceiling wall portion 23 of the housing 11 includes a notched recession portion 23a formed by cutting out a rectangular recession along the mating direction X1. When the plug housing 103 of the plug connector 101 is fitted into the housing 11 through the opening 21, the lock arm 104 of the plug connector 101 is disposed in the notched recession portion 23a. The engaging portion 13b provided on the shield member 13 mounted to the outer side of the housing 11 is disposed above the notched recession portion 23a in the height direction X3. When the plug connector 101 is fitted into the housing 11 through the opening 21, the engagement protrusion portions 104a of the lock arm 104 disposed in the notched recession portion 23a engage with the engaging portion 13b of the shield member 13.

### <Contact>

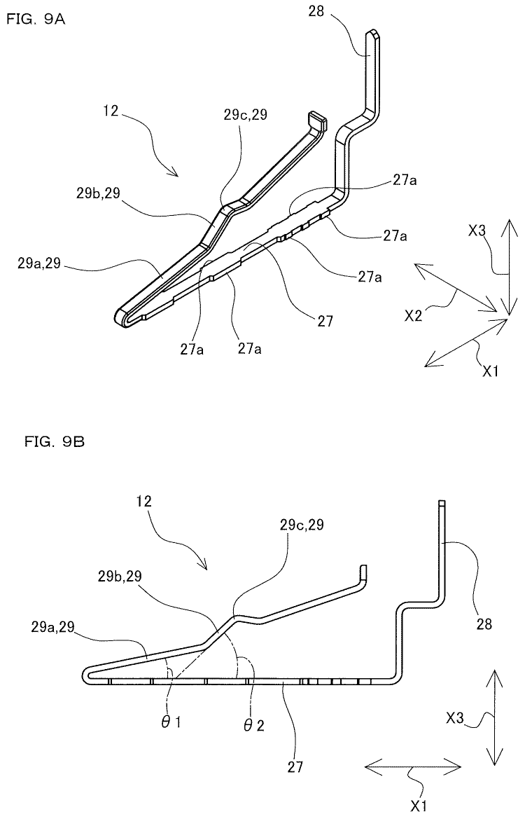

FIGS. 9A and 9B are views of one contact 12 of the electrical connector 1, with FIG. 9A being a perspective view and FIG. 9B being a side view. As shown in FIGS. 1A to 3 and 6 to 9B, the contacts 12 are held in the housing 11, are electrically connected to the substrate 100 when the electrical connector 1 is disposed on the substrate 100, and are respectively electrically connected to the plug contacts 102 of the plug connector 101 when the electrical connector 1 is connected to the plug connector 101. The contacts 12 are inserted into the housing 11 through the slit grooves 26a along the mating direction X1 and are press-fitted into the holding grooves 22a of the bottom wall portion 22 of the housing 11, thereby being held in the bottom wall portion 22. The contacts 12 held by the housing 11 in the bottom wall portion 22 are held by the housing 11 in a state of being side by side in the width direction X2.

As shown in FIGS. 1A to 3 and 6 to 9B, the contacts 12 are each formed by bending a long, thin, and straight plate-shaped metal member. Each of the contacts 12 is configured such that, while held in the housing 11, one end side is connected to the substrate 100 and electrically connected to the substrate 100, and the other end side is in contact with a corresponding plug contact 102 and electrically connected to the plug contact 102. More specifically, each of the contacts 12 has a body portion 27 held in the housing 11, a substrate connection portion 28 provided on one end side of the body portion 27 and connected to the substrate 100, and a plug connection portion 29 provided on the other end side of the body portion 27 and connected to a corresponding plug contact 102.

As shown in FIGS. 6 to 9B, the body portion 27 of the contact 12 is provided as a portion that extends in a straight line and is held by the bottom wall portion 22 of the housing 11. The body portion 27 is shaped as a straight, long, and thin plate, and when inserted and held in the housing 11, the contact 12 is press-fitted into a corresponding holding groove 22a of the bottom wall portion 22 of the housing 11 along the mating direction X1. Upon being fitted into the holding groove 22a of the bottom wall portion 22 and held by the bottom wall portion 22, the body portion 27 is held in a state of extending in a straight line along the mating direction X1 in the bottom wall portion 22. Note that the body portion 27 is provided with small, protruding press-fit claws 27a on both sides in the width direction X2. When the body portion 27 is fitted into the holding groove 22a, the press-fit claws 27a bite into and engage with the inner walls of the holding groove 22a, and thereby the body portion 27 is press-fitted into the holding groove 22a, and the contact 12 is held in the bottom wall portion 22.

As shown in FIGS. 6 to 9B, the substrate connection portion 28 of the contact 12 is provided so as to extend from one end side of the body portion 27 in the mating direction X1, and is the portion that is to be connected to the substrate 100. The substrate connection portion 28 is provided so as to bend from the end portion on the one end side of the body portion 27 at substantially a right angle relative to the body portion 27 and extend along the height direction X3, and is connected to the substrate 100 by the leading end side extending in the height direction X3 being inserted into a through hole 100b provided in the substrate 100 (see FIGS. 6 and 8). The substrate connection portion 28 is electrically connected to the substrate 100 by being soldered while inserted into the through hole 100b of the substrate 100 (the solder is not shown in FIGS. 6 and 8). While the contact 12 is held in the body portion 27 by the bottom wall portion 22 of the housing 11, the substrate connection portion 28 extending from the one end side of the body portion 27 passes through a corresponding slit groove 26a in the end wall portion 26 of the housing 11 and extends along the height direction X3 outside the housing 11. While the electrical connector 1 is disposed on the substrate 100, the substrate connection portion 28 extending outside the housing 11 is electrically connected to the substrate 100.

As shown in FIGS. 6 to 9B, the plug connection portion 29 of the contact 12 bends at an acute angle relative to the body portion 27 from the other end side of the body portion 27 in the mating direction X1 and extends in a cantilevered manner inside the opening 21 of the housing 11. Also, the plug connection portion 29 bends at an acute angle relative to the body portion 27 from the end portion of the body portion 27, which is held by the bottom wall portion 22 of the housing 11, that faces the opening 21, and extends in a cantilevered manner inside the housing 11. The plug connection portion 29 is provided as the portion that, when the plug connector 101 is mated and connected to the electrical connector 1, comes into contact with the corresponding plug contact 102 of the plug connector 101 and is electrically connected to the plug contact 102. The plug connection portion 29, which bends at an acute angle relative to the body portion 27 and extends in a cantilevered manner from the body portion 27, is configured to elastically deform and flex upon coming into contact with the plug contact 102, and thereby be electrically connected to the plug contact 102.

More specifically, the plug connection portion 29 has a plate spring portion 29a that bends from the body portion 27 and then extends in a straight line, an inclined portion 29b that is inclined relative to the plate spring portion 29a and extends further from the plate spring portion 29a, and a contact portion 29c that is provided on the inclined portion 29b and is connected to the plug contact 102.

The plate spring portion 29a of the plug connection portion 29 bends at an acute angle relative to the body portion 27 from the end portion of the body portion 27 that faces the opening 21 and then extends in a straight line, and extends obliquely at an acute angle relative to the mating direction X1 while moving away from the bottom wall portion 22 in the height direction X3 inside the opening 21. The plate spring portion 29a is configured as a plate spring-like portion that elastically deforms and flexes when the plug connection portion 29 and the plug contact 102 come into contact with each other and are connected.

The inclined portion 29b extends in an inclined manner from the plate spring portion 29a so as to protrude away from the body portion 27 relative to the plate spring portion 29a. The inclined portion 29b is bent and inclined relative to the plate spring portion 29a. The inclined portion 29b extends in a continuous straight line from the plate spring portion 29a, and is continuous with the plate spring portion 29a at the terminal end portion of the plate spring portion 29a that bends from the end portion of the body portion 27 and extends in a straight line, and furthermore the inclined portion 29b bends away from the body portion 27 relative to the plate spring portion 29a and then extends in a straight line at an angle different from that of the plate spring portion 29a. As shown in FIG. 9B, the plate spring portion 29a bends from the body portion 27 and then extends so as to form a predetermined first angle θ1 with the body portion 27. The inclined portion 29b extends in an inclined manner from the plate spring portion 29a so as to form a predetermined second angle θ2 , which is larger than the first angle θ1 , with the body portion 27. In other words, in the plug connection portion 29, the plate spring portion 29a extends so as to form the first angle θ1 that forms a relatively small acute angle with the body portion 27, and the inclined portion 29b extends so as to form the second angle θ2 that forms a larger acute angle than the first angle θ1 with the body portion 27.

The contact portion 29c of the plug connection portion 29 is provided on the inclined portion 29b and is configured as the portion that comes into contact with the plug contact 102 and is electrically connected to the plug contact 102. The contact portion 29c is provided as the highest portion of the inclined portion 29b that extends in an inclined manner from the plate spring portion 29a so as to protrude away from the body portion 27 relative to the plate spring portion 29a. The contact portion 29c is configured to be electrically connected to the plug contact 102 by coming into contact with the bottom face portion 102a of the plug contact 102 that faces the bottom wall portion 22 of the housing 11 when the plug connector 101 is mated to the electrical connector 1.

### Connection Between Electrical Connector and Plug Connector

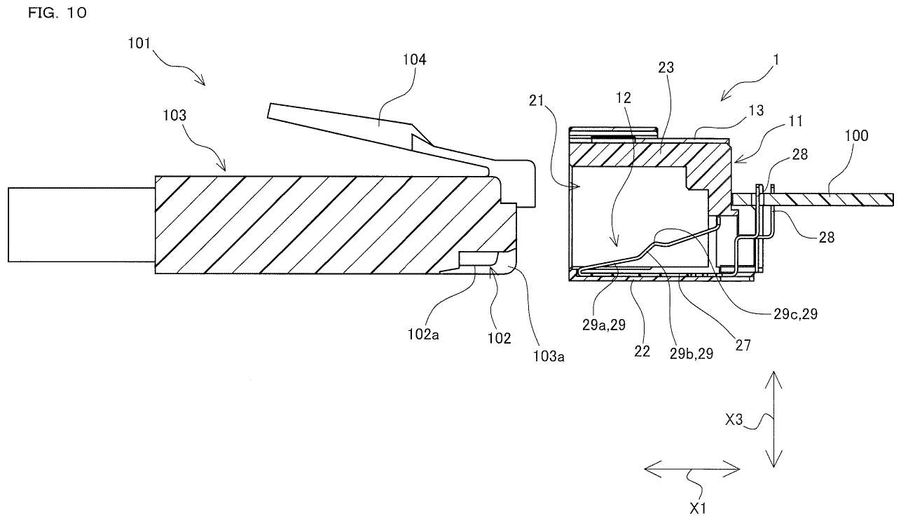

Next, operations of connecting the electrical connector 1 and the plug connector 101 to each other will be described. FIG. 10 is a cross-sectional view of the state before the electrical connector 1 and the plug connector 101 are connected. As shown in FIGS. 2 and 10, the electrical connector 1 is connected to the substrate 100 before being connected to the plug connector 101. One end portion of the plug connector 101 in the mating direction X1 is inserted into the opening 21 of the housing 11 of the electrical connector 1, and the plug connector 101 is mated to the electrical connector 1, and thereby the plug connector 101 and the electrical connector 1 are connected.

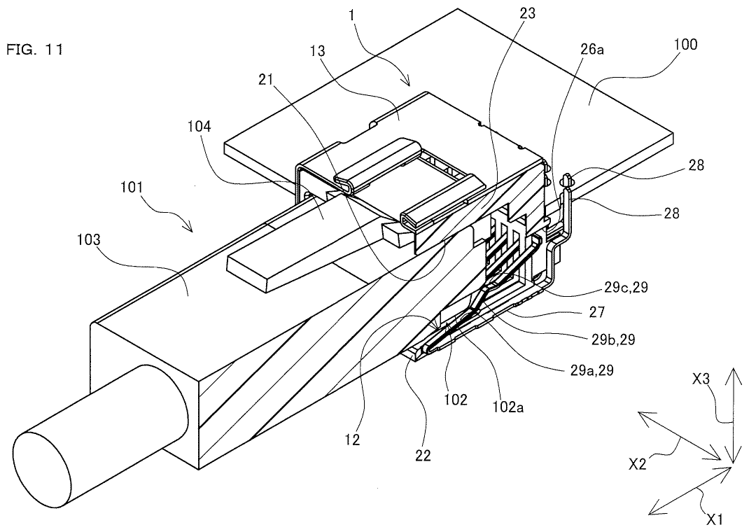

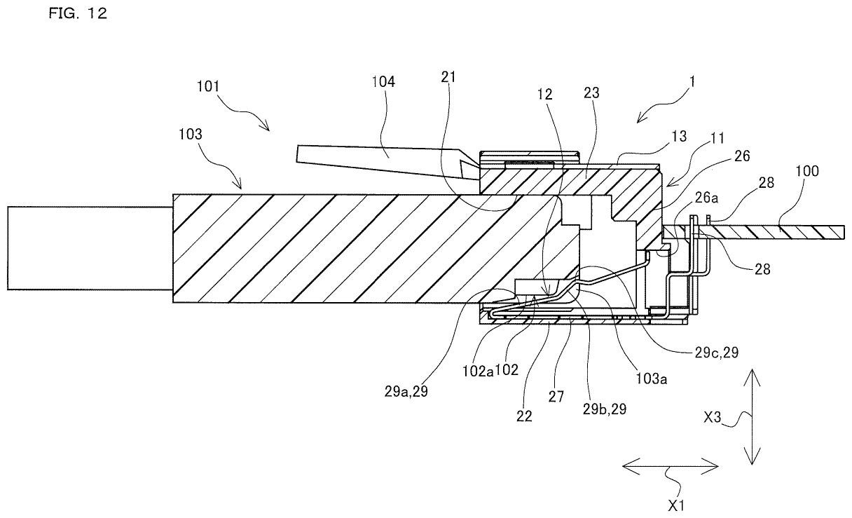

FIG. 11 is a perspective cross-sectional view of a state in which the plug connector 101 is being mated and connected to the electrical connector 1. FIG. 12 is a cross-sectional view of a state in which the plug connector 101 is being mated and connected to the electrical connector 1. As shown in FIGS. 11 and 12, when the plug connector 101 is connected to the electrical connector 1, one end portion of the plug connector 101 in the mating direction X1 is inserted into the opening 21 of the housing 11 of the electrical connector 1. The plug connector 101 is mated to the electrical connector 1 by inserting the end portion of the plug connector 101 deep into the opening 21 of the housing 11 in the mating direction X1. When the plug connector 101 is inserted into the opening 21 of the housing 11, the plug connection portions 29 of the contacts 12 are inserted into the grooves between the electrode separation walls 103a of the plug housing 103. The body portions 27 of the contacts 12 are held by the bottom wall portion 22 of the housing 11, and the plug connection portions 29 extend inside the opening 21 of the housing 11. When the plug connector 101 is inserted into the opening 21 of the housing 11, the plug connection portions 29 extending inside the opening 21 are inserted into the grooves between the electrode separation walls 103a of the plug housing 103.

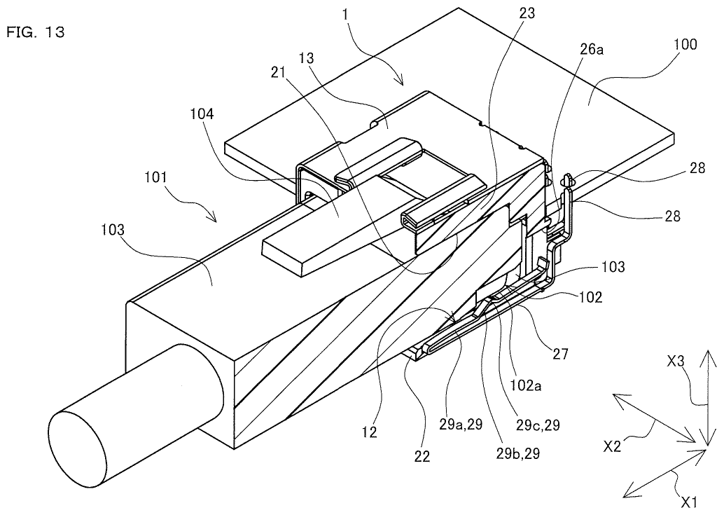

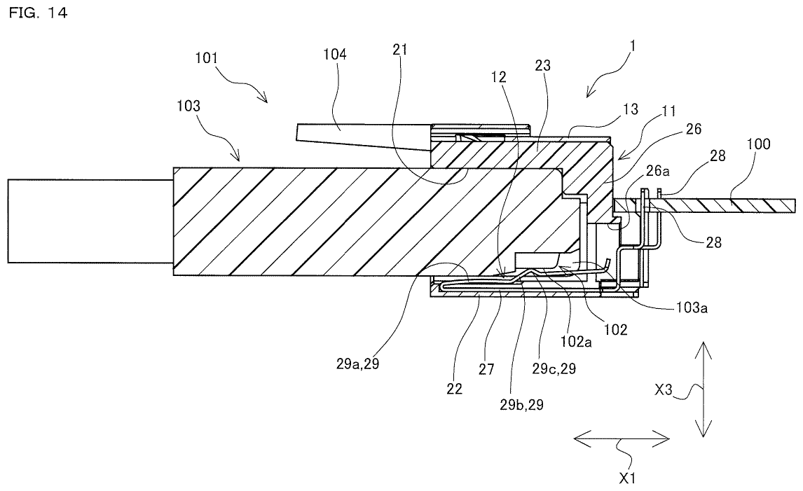

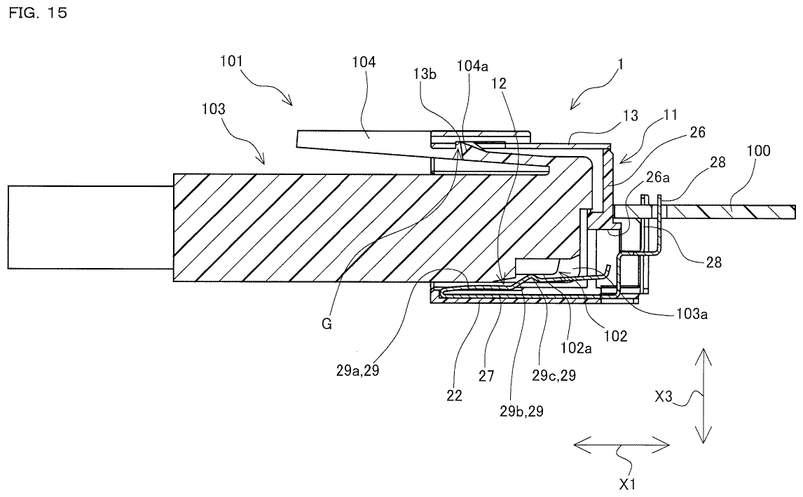

FIG. 13 is a perspective cross-sectional view of a state in which the plug connector 101 has been mated and connected to the electrical connector 1. FIGS. 14 and 15 are cross-sectional views of a state in which the plug connector 101 has been mated and connected to the electrical connector 1. Note that FIGS. 14 and 15 show cross sections taken perpendicular to the width direction X2 at different positions. FIG. 14 is a cross-sectional view at a position corresponding to FIG. 13, and FIG. 15 is a cross-sectional view at a position where one engagement protrusion portion 104a of the lock arm 104 of the plug connector 101 and the engaging portion 13b of the shield member 13 of the electrical connector 1 are visible.

As shown in FIGS. 13 to 15, when the plug connector 101 is inserted deep into the opening 21 of the housing 11 of the electrical connector 1, the plug connector 101 is mated to the electrical connector 1, and the plug connector 101 and the electrical connector 1 are connected to each other. When the plug connector 101 is mated and connected to the electrical connector 1, the lock arm 104 of the plug connector 101 comes into contact with the shield member 13 of the electrical connector 1 so as to temporarily flex, and then undergoes elastic recovery such that the engagement protrusion portions 104a engage with the engaging portion 13b of the shield member 13. The engagement protrusion portions 104a of the lock arm 104 engage with the engaging portion 13b of the shield member 13 in the direction in which the plug connector 101 is pulled out of the electrical connector 1 along the mating direction X1, thereby preventing the plug connector 101 from coming out of the electrical connector 1.

Here, the mode of electrical connection between one plug contact 102 and one contact 12 when the plug connector 101 is mated and connected to the electrical connector 1 will be described in more detail. As shown in FIGS. 12 to 15, as the plug connector 101 is inserted deeper into the opening 21, the inclined portion 29b of the plug connection portion 29 of the contact 12, which has been inserted into the groove between the electrode separation walls 103a in the plug housing 103, comes into contact with the end portion of the plug contact 102. When the inclined portion 29b comes into contact with the end portion of the plug contact 102, the inclined portion 29b extending in an inclined manner from the plate spring portion 29a is urged by the end portion of the plug contact 102 such that the plate spring portion 29a elastically deforms so as to flex toward the bottom wall portion 22 of the housing 11. When the plug connector 101 is inserted deep into the opening 21 and mated to the housing 11, the plate spring portion 29a, which has flexed toward the bottom wall portion 22, flexes to a position outside of the groove between the electrode separation walls 103a in the plug housing 103, and the contact portion 29c provided at the highest portion of the inclined portion 29b comes into contact with the bottom face portion 102a of the plug contact 102. In other words, as the plate spring portion 29a flexes, the inclined portion 29b becomes displaced so as to slide against the end portion of the plug contact 102 and enter the region between the bottom face portion 102a of the plug contact 102 and the bottom wall portion 22, and the contact portion 29c provided at the highest portion of the inclined portion 29b comes into contact with the bottom face portion 102a of the plug contact 102. When the plug connector 101 is mated to the electrical connector 1, the contact portion 29c of the plug connection portion 29 is in contact with the bottom face portion 102a of the plug connector 101, and the contact 12 and the plug contact 102 are electrically connected to each other.

Furthermore, when the plug connector 101 is mated to the electrical connector 1 and the contact portion 29c of the plug connection portion 29 comes into contact with the bottom face portion 102a of the plug contact 102 such that the contact 12 and the plug contact 102 are electrically connected to each other, the plate spring portion 29a is in a state of flexing to a position outside of the groove between the electrode separation walls 103a in the plug housing 103. Also, almost no portion of the plate spring portion 29a is located next to the electrode separation walls 103a of the plug housing 103, and substantially only the inclined portion 29b is located at a such a position. In other words, the plate spring portion 29a is not overlapped with the electrode separation walls 103a in the width direction X2, and only the inclined portion 29b, which protrudes from the plate spring portion 29a, is located so as to face the electrode separation walls 103a in the width direction X2. Therefore, even if the plug connector 101 becomes displaced so as to twist relative to the housing 11, the portion of the contact 12 that interferes with the electrode separation walls 103a of the plug connector 101 is substantially only the inclined portion 29b, and the plug connection portion 29 is prevented from overall being pushed down toward the bottom wall portion 22 of the housing 11.

Note that an example of a case in which the plug connector 101 becomes displaced so as to twist relative to the housing 11, there is a case where, after the plug connector 101 and the electrical connector 1 are mated and connected to each other, an external force acts on the plug connector 101 such that the plug connector 101 becomes displaced relative to the housing 11 so as to slightly swing along the width direction X2. When the plug connector 101 and the electrical connector 1 are mated and connected to each other, even if the plug connector 101 swings slightly along the width direction X2 and the plug connector 101 becomes displaced so as to twist relative to the housing 11, the portion of the contact 12 that interferes with the electrode separation walls 103a of the plug connector 101 is substantially only the inclined portion 29b, and the plug connection portion 29 is prevented from overall being pushed down toward the bottom wall portion 22 of the housing 11. Therefore, even if the plug connector 101 becomes displaced so as to twist relative to the housing 11, it is possible to suppress the case where the plug connection portion 29 of the contact 12 and the plug contact 102 momentarily separate such that the contact therebetween is momentarily lost, and it is possible to suppress the case where the electrical connection between the contact 12 and the plug contact 102 is momentarily lost.

As shown in FIG. 15, when the plug connector 101 is mated to the electrical connector 1 and the plug connector 101 and the electrical connector 1 are connected to each other, the engagement protrusion portions 104a of the lock arm 104 can engage with the engaging portion 13b of the shield member 13 in the direction in which the plug connector 101 is pulled out of the electrical connector 1. However, when no external force is acting on the plug connector 101 in the direction of pulling it out of the electrical connector 1, a small gap G is formed between the engagement protrusion portion 104a of the lock arm 104 and the engaging portion 13b of the shield member 13. In this state, if an external force acts on the plug connector 101 so as to swing along the width direction X2, the plug connector 101 becomes displaced so as to twist relative to the housing 11. However, even if the plug connector 101 becomes displaced so as to twist relative to the housing 11, the portion of the contact 12 that interferes with the electrode separation walls 103a of the plug connector 101 is substantially only the inclined portion 29b, and the plug connection portion 29 is prevented from overall being pushed down toward the bottom wall portion 22 of the housing 11.

### Effects of Embodiment

According to the present embodiment, each of the contacts 12 is provided with the plug connection portion 29 that bends from the body portion 27, which is held by the bottom wall portion 22 of the housing 11, at an acute angle relative to the body portion 27, and extends inside the opening 21 of the housing 11. The plug connection portion 29 is provided with the plate spring portion 29a that bends from the body portion 27 and then extends in a straight line, the inclined portion 29b that extends in an inclined manner from the plate spring portion 29a so as to protrude away from the body portion 27 relative to the plate spring portion 29a, and the contact portion 29c that is provided on the inclined portion 29b and comes into contact with and is connected to the plug contact 102. In this way, in the plug connection portion 29 of the contact 12, the inclined portion 29b provided with the contact portion 29c is provided so as to protrude from the plate spring portion 29a, and therefore when the plug connector 101 is mated and connected to the housing 11, almost no portion of the plate spring portion 29a is located next to the electrode separation walls 103a of the plug connector 101, and only the inclined portion 29b is located at such a position. Therefore, even if the plug connector 101 becomes displaced so as to twist relative to the housing 11, the portion of the contact 12 that interferes with the electrode separation walls 103a of the plug connector 101 is substantially only the inclined portion 29b, and the plug connection portion 29 is prevented from overall being pushed down toward the bottom wall portion 22 of the housing 11. Accordingly, even if the plug connector 101 becomes displaced so as to twist relative to the housing 11, it is possible to suppress the case where the plug connection portion 29 of the contact 12 momentarily separates from the plug contact 102 and the contact therebetween is momentarily lost, and it is possible to suppress the case where the electrical connection between the contact 12 and the plug contact 102 is momentarily lost.

Therefore, according to the present embodiment, in the receptacle-type electrical connector 1 that is disposed on the substrate 100 and to which the plug connector 101 having the plug contacts 102 is to be mated and connected, even if the plug connector 101 becomes displaced so as to twist relative to the housing 11, it is possible to suppress the case where the electrical connection between the contacts 12 and the plug contacts 102 is momentarily lost.

Furthermore, according to the present embodiment, the angle θ2 of the inclined portion 29b of the plug connection portion 29 relative to the body portion 27 is set larger than the angle θ1 of the plate spring portion 29a of the plug connection portion 29 relative to the body portion 27, and therefore the plug connection portion 29 can be easily formed with a structure in which, when the plug connector 101 is mated to the housing 11, almost no portion of the plate spring portion 29a is located next to the electrode separation walls 103a of the plug connector 101, and the inclined portion 29b is located at such a position.

Furthermore, according to the present embodiment, the contact portion 29c of the plug connection portion 29 is connected to the plug contact 102 by coming into contact with the bottom face portion 102a of the plug contact 102, and therefore even if the plug connector 101 becomes displaced so as to twist relative to the housing 11, the contact portion 29c is likely to follow movement of the plug contact 102, and the contact portion 29c is even less likely to separate from the plug contact 102. This further suppresses the case where the electrical connection between the contact 12 and the plug contact 102 is momentarily lost.

Also, according to the present embodiment, with a simple structure in which the inclined portion 29b is formed to be bent relative to the plate spring portion 29a, it is possible to construct the contact 12 with a structure in which, even if the plug connector 101 becomes displaced so as to twist relative to the housing 11, the portion of the contact 12 that interferes with the electrode separation walls 103a of the plug connector 101 is substantially only the inclined portion 29b, and the plug connection portion 29 can be prevented from overall being pushed down toward the bottom wall portion 22 of the housing 11.

### Variations

Although one embodiment of the present invention has been described above, the present invention is not limited to the above embodiment, and various modifications can be made without departing from the scope of the claims. In other words, the present invention is not limited to the above-described embodiments, and it is intended that all variations and applications that are within the scope of the claims and their equivalents, which will become apparent upon reading and understanding this specification, are included within the scope of the present invention. For example, modifications such as the following may be made.

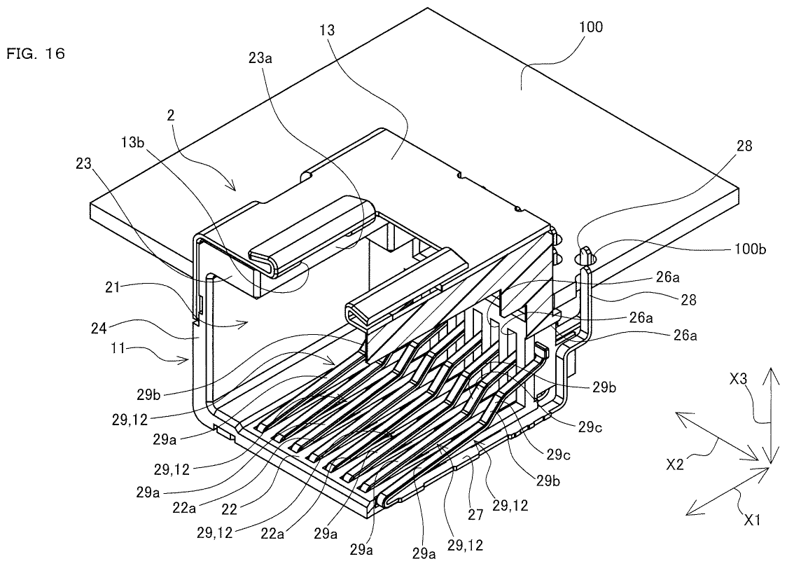

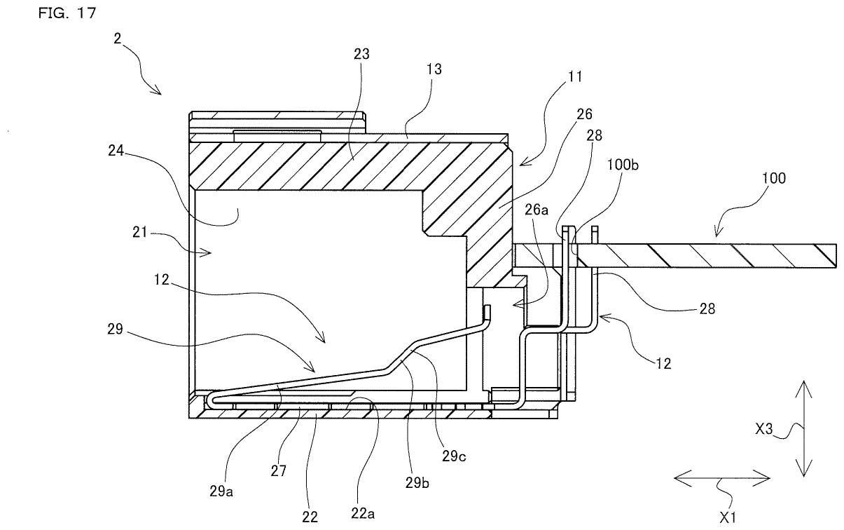

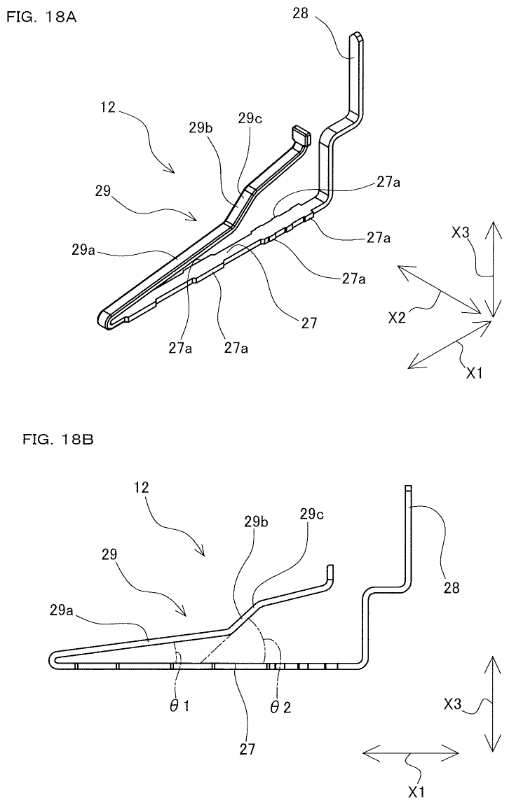

FIG. 16 is a perspective cross-sectional view of an electrical connector 2 according to a variation. FIG. 17 is a cross-sectional view of the electrical connector 2 according to the variation. FIGS. 18A and 18B are views of a contact 12 in the electrical connector 2 according to the variation, with FIG. 18A being a perspective view and FIG. 18B being a side view.

The electrical connector 2 of this variation has a configuration similar to that of the electrical connector 1 of the above-described embodiment, but differs from the electrical connector 1 of the above-described embodiment with respect to the manner in which the plug connection portion 29 of the contact 12 and the plug contact 102 come into contact and are connected to each other. The following description of the electrical connector 2 according to this variation focuses only on the configurations that differ from the electrical connector 1 of the above-described embodiment. Furthermore, regarding elements that have a configuration similar to that in the above-described embodiment and elements having a configuration corresponding to an element in the above-described embodiment, the same reference signs will be used in the drawings, and the same reference signs will be quoted in the description, and duplicate descriptions will not be given for such elements.

As shown in FIGS. 16 to 18B, in an electrical connector 2 according to this variation, the configuration regarding the position of the contact portion 29c in the plug connection portion 29 of the contact 12 differs from that of the electrical connector 1 of the above-described embodiment. In the plug connection portion 29 of the contact 12 of the electrical connector 2, the plate spring portion 29a extends with a longer length than the plug connection portion 29 of the contact 12 of the electrical connector 1. The contact portion 29c provided on the inclined portion 29b is not provided at the highest portion of the inclined portion 29b, but rather is provided as an intermediate portion of the inclined portion 29b that extends in an inclined manner from the plate spring portion 29a. As a result, the contact portion 29c provided on the inclined portion 29b is configured to come into contact with and be connected to a corner portion of an end portion of the plug contact 102, rather than the bottom face portion 102a of the plug contact 102.

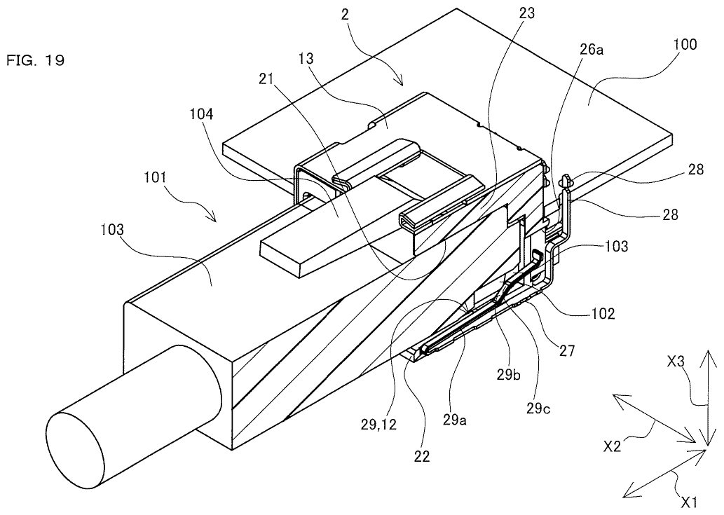

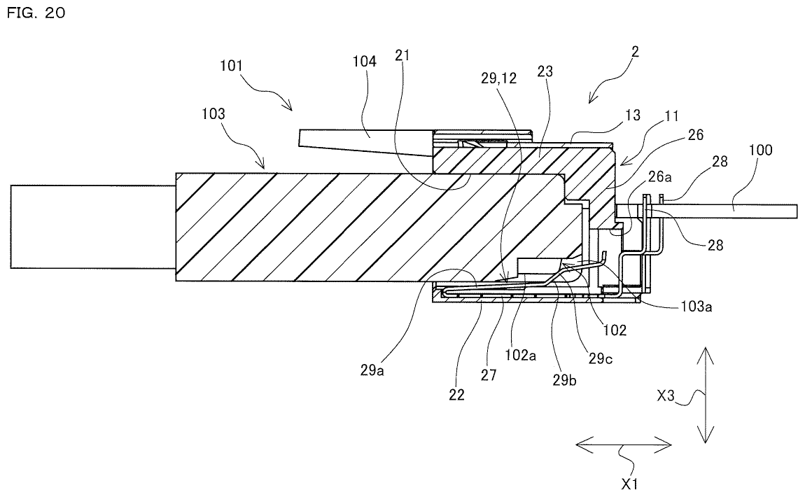

FIG. 19 is a perspective cross-sectional view of a state in which the plug connector 101 has been mated and connected to the electrical connector 2. FIG. 20 is a cross-sectional view of a state in which the plug connector 101 has been mated and connected to the electrical connector 2. As shown in FIGS. 19 and 20, as the plug connector 101 is inserted deeper into the opening 21, the inclined portion 29b of the plug connection portion 29 of the contact 12, which has been inserted into the groove between the electrode separation walls 103a in the plug housing 103, comes into contact with the end portion of the plug contact 102. In the electrical connector 2, the length of the plate spring portion 29a of the plug connection portion 29 of the contact 12 is set to extend longer than the length of the plate spring portion 29a of the plug connection portion 29 of the contact 12 of the electrical connector 1. Therefore, when the plug connector 101 is inserted deeper into the opening 21, the inclined portion 29b of the plug connection portion 29 comes into contact with the end portion of the plug contact 102. The portion of the inclined portion 29b that comes into contact with the plug contact 102 is the corner portion that faces the bottom wall portion 22 at the end portion of the plug contact 102.

When the plug connector 101 is inserted deep into the opening 21 and the corner portion of the end portion of the plug contact 102 comes into contact with the inclined portion 29b, the inclined portion 29b is urged by the end portion of the plug contact 102, and the plate spring portion 29a elastically deforms so as to flex toward the bottom wall portion 22 of the housing 11. When the plug connector 101 is inserted deep into the opening 21 and mated to the housing 11, the plate spring portion 29a, which has flexed toward the bottom wall portion 22, flexes to a position outside of the groove between the electrode separation walls 103a in the plug housing 103, and the contact portion 29c, which is provided as an intermediate portion of the inclined portion 29b extending from the plate spring portion 29a, comes into contact with the corner portion of the end portion of the plug contact 102. In other words, as the plate spring portion 29a flexes, the inclined portion 29b becomes displaced so as to slide against the corner portion of the end portion of the plug contact 102 and shift the position of contact with the corner portion of the end portion of the plug contact 102, and the contact portion 29c provided in the intermediate portion of the inclined portion 29b extending from the plate spring portion 29a comes into contact with the corner portion of the end portion of the plug contact 102. When the plug connector 101 has been mated to the electrical connector 2, the contact portion 29c of the plug connection portion 29 is in contact with the corner portion of the end portion of the plug contact 102, and the contact 12 and the plug contact 102 are electrically connected to each other.

In the electrical connector 2 of the present variation, the contact 12 is provided with the plug connection portion 29 that bends from the body portion 27, which is held by the bottom wall portion 22 of the housing 11, and bends at an acute angle relative to the body portion 27, and extends inside the opening 21 of the housing 11. The plug connection portion 29 is provided with the plate spring portion 29a that bends from the body portion 27 and then extends in a straight line, the inclined portion 29b that extends in an inclined manner from the plate spring portion 29a so as to protrude away from the body portion 27 relative to the plate spring portion 29a, and the contact portion 29c that is provided on the inclined portion 29b and comes into contact with and is connected to the plug contact 102. In this way, in the plug connection portion 29 of the contact 12, the inclined portion 29b provided with the contact portion 29c is provided so as to protrude from the plate spring portion 29a, and therefore when the plug connector 101 is mated and connected to the housing 11, almost no portion of the plate spring portion 29a is located next to the electrode separation walls 103a of the plug connector 101, and only the inclined portion 29b is located at such a position. Therefore, even if the plug connector 101 becomes displaced so as to twist relative to the housing 11, the portion of the contact 12 that interferes with the electrode separation walls 103a of the plug connector 101 is substantially only the inclined portion 29b, and the plug connection portion 29 is prevented from overall being pushed down toward the bottom wall portion 22 of the housing 11. Accordingly, even if the plug connector 101 becomes displaced so as to twist relative to the housing 11, it is possible to suppress the case where the plug connection portion 29 of the contact 12 momentarily separates from the plug contact 102 and the contact therebetween is momentarily lost, and it is possible to suppress the case where the electrical connection between the contact 12 and the plug contact 102 is momentarily lost.

Therefore, according to the present variation, in the receptacle-type electrical connector 2 that is disposed on the substrate 100 and to which the plug connector 101 having the plug contacts 102 is to be mated and connected, even if the plug connector 101 becomes displaced so as to twist relative to the housing 11, it is possible to suppress the case where the electrical connection between the contacts 12 and the plug contacts 102 is momentarily lost.

### INDUSTRIAL APPLICABILITY

The present invention is broadly applicable to receptacle-type electrical connectors that are disposed on a substrate and to which a plug connector having plug contacts is to be mated and connected.

### DESCRIPTION OF REFERENCE SIGNS

1, 2 Electrical connector
11 Housing
12 Contact
13 Shield member
13a Tab
13b Engaging portion
21 Opening
22 Bottom wall portion
23 Ceiling wall portion
23a Notched recession portion
24, 25 Side wall portion
26 End wall portion
26a Slit groove
27 Body portion
28 Substrate connection portion
29 Plug connection portion
29a Plate spring portion
29b Inclined portion
29c Contact portion
100 Substrate
100a Recession portion
100b Through hole
101 Plug connector
102 Plug contact
102a Bottom face portion
103 Plug housing
103a Electrode separation wall
104 Lock arm
104a Engagement protrusion portion
105 Tube

What is claimed is:

1. A receptacle-type electrical connector to be disposed on a substrate and to which a plug connector having a plug contact is to be mated and connected, the electrical connector comprising:
a contact having one end side configured to be connected to the substrate and electrically connected to the substrate, and another end side configured to come into contact with the plug contact and be electrically connected to the plug contact; and
a housing configured to hold the contact, and to which the plug connector is mateable,
wherein the housing has:
an opening into which the plug connector is fitted; and
a bottom wall portion configured to hold the contact,
the contact has:
a body portion extending in a straight line and configured to be held by the bottom wall portion of the housing;
a substrate connection portion extending from one end side of the body portion and configured to be connected to the substrate; and
a plug connection portion bending at an acute angle relative to the body portion from another end side of the body portion and extending in a cantilevered manner inside the opening of the housing, and configured to, upon coming into contact with the plug contact, elastically deform and flex and be connected to the plug contact, and
the plug connection portion has:
a plate spring portion bending from the body portion and then extending in a straight line;
an inclined portion extending in an inclined manner from the plate spring portion so as to protrude away from the body portion relative to the plate spring portion; and
a contact portion provided on the inclined portion and configured to come into contact with the plug contact and be electrically connected to the plug contact.

2. The electrical connector according to claim 1,
wherein the plate spring portion bends from the body portion and then extends so as to form a predetermined first angle with the body portion, and
the inclined portion extends in an inclined manner from the plate spring portion so as to form a predetermined second angle with the body portion, the second angle being larger than the first angle.

3. The electrical connector according to claim 1,
wherein the plug contact is provided with a bottom face portion configured to face the bottom wall portion of the housing when the plug connector is mated to the housing, and
the contact portion is provided as a highest portion of the inclined portion that extends in an inclined manner from the plate spring portion so as to protrude away from the body portion relative to the plate spring portion, and the contact portion is connected to the plug contact by coming into contact with the bottom face portion.

4. The electrical connector according to claim 1,
wherein the inclined portion bends so as to be inclined relative to the plate spring portion.
